(19) United States
(12) Patent Application Publication
(10) Pub. No.: US 2022/0344629 A1
(43) Pub. Date: Oct. 27, 2022

(54) METHOD FOR PRODUCING BATTERY, AND BATTERY

(71) Applicant: MTEK-SMART CORPORATION, Yokohama-Shi, Kanagawa (JP)

(72) Inventor: Masafumi MATSUNAGA, Yokohama-Shi (JP)

(73) Assignee: MTEK-SMART CORPORATION, Yokohama-Shi, Kanagawa (JP)

(21) Appl. No.: 17/635,520

(22) PCT Filed: Aug. 4, 2020
(86) PCT No.: PCT/JP2020/029802

§ 371 Date: Feb. 15, 2022

(30) Foreign Application Priority Data
Aug. 23, 2019 (JP) 2019-153156

(51) Int. Cl. H01M 4/04; H01M 4/88

(52) U.S. Cl. CPC H01M 4/0435; H01M 4/0404; H01M 4/8828; H01M 4/0419; H01M 8/1004

(57) ABSTRACT

A small diameter roll is provided on the upstream side of a heating and sucking roll, an electrode slurry is applied by using a slot nozzle on the small diameter roll or an OFF roll, and an electrode is formed by instantaneously evaporating a solvent by the heating and sucking roll.

### TECHNICAL FIELD

The present invention relates to a method for producing a battery by using an applying method that eliminates a need for a mask when a material for a battery is applied on a substrate or does not place importance on the mask.

More specifically, the present invention relates to a battery such as a fuel cell and a secondary battery produced by an applying method by a head called a slot die, a slit die, a slot nozzle, etc., in the industry of applying electrode slurry or electrolyte material, etc. to a long battery substrate, for example a fuel cell and secondary battery substrate with a liquid film such as mainly a slurry.

Alternatively, the present invention relates to a method for producing a battery at a level at which particles do not scatter outside a desired applying pattern or the performance is not affected when applying mist-made electrode slurry or two-fluid sprayed electrode slurry using compressed gas, etc. to a substrate.

A secondary battery is a storage battery that charges and discharges, and the second battery includes, for example, a lithium ion secondary battery, a lithium ion polymer battery, typical next-generation secondary battery such as an all-solid-state battery, a semi-solid battery and a metal air battery.

A material and shape of a substrate are not particularly limited, and the substrate may be a substrate for a fuel cell and a secondary battery, for example, a metal foil such as an aluminum, a copper, and a stainless steel, a current collector of positive and negative electrodes of polymer conductive film, a separator, an electrolyte polymer for a semi-solid battery, an all solid electrolyte layer, an electrode layer including an active material formed on a current collector, and an electrolyte layer laminated on an electrode layer, etc.

A substrate of a fuel cell has an electrolyte membrane and a gas diffusion layer. In case of a secondary battery, a material used for applying may be an electrode slurry for a positive electrode or a negative electrode including an active material, an electrolyte polymer solution, an electrolyte slurry, etc., and when applying is performed by a slot nozzle, a mask is not needed even when applying a pattern is performed, thereby it is particularly effective in terms of productivity.

Further, a slot nozzle in the present invention is used in a method of applying while flowing a compressed gas for assisting the applying in at least one side of an opening through which at least a slurry of a head flows, or, a method of applying by micro curtain coat while spraying a liquid by an airless spray nozzle at a low pressure, for example, a hydraulic pressure of about 0.2 to 0.5 MPa and wrapping a spray pattern using one nozzle or more nozzles at a part of a liquid film before it becomes spray particles.

Further, the present invention also includes a method of applying by a mist ejection nozzle including generating slurry particles (mists) in an opening of a slit or upstream of the slit and ejecting the mists from the opening.

Further, the present invention includes a method of applying by a melt blown spray nozzle head in which multiple spray nozzles with a narrow nozzle spray angle of 20 degrees or less are arranged in one row or multiple rows and each of multiple spray nozzles fiberizes or granulates melts and liquids with compressed gas.

The present invention can also be applied to production of a capacitor such as an electric double layer capacitor called supercapacitor and a multilayer ceramic capacitor (MLCC). The present invention can also be applied to production of an all-solid-state battery that utilize a structure of MLCC.

### BACKGROUND

Conventionally, an active material slurry for a positive electrode or a negative electrode is applied to a current collector for a lithium ion secondary battery with a slot nozzle in an intermittent pattern or continuously and dried. In general, a slurry mainly for positive electrodes is mainly composed of an active material particle, for example, a ternary system, a binder such as vinylidene fluoride (PVDF), and a solvent, and, in case of the positive electrode, carbon nanofibers, single-walled carbon nanotubes or graphene as a conductive auxiliary agent are preferably used as the slurry.

On the other hand, a slurry for negative electrodes is formed by adding a binder and a solvent to an active material containing only carbon or an active material obtained by adding silicon or silicon oxide (SiOx) to carbon and the slurry is applied in an intermittent pattern or continuously and dried.

A rubber binder is used as a binder for negative electrodes, and water is often used as a solvent. On the other hand, when a slot nozzle is used to form an electrode of a fuel cell and a back roll facing the slot nozzle head is heated, a vicinity of a tip of the slot nozzle dries, therefore an attempt to cool the back roll is performed to prevent a drying.

Patent document 1 discloses a method for creating a cathode of a lithium ion secondary battery by a slot die (nozzle), etc.

Patent document 2 discloses a method for producing an electrode slurry on an electrolyte membrane for a fuel cell by a roll-to-roll method using a slot die (nozzle).

On the other hand, a positive electrode of an all-solid-state battery is formed by adding an active material particle, an electrolyte particle, if necessary a carbon or a carbon nanofiber as a conductive aid and a solvent to form a slurry, applying the slurry to a substrate such as a current collector by a spray or a slot nozzle, etc. In addition, since a binder becomes non-uniform residual coal when the binder is fired, it was ideal to add a minimum of binder.

Further, in case of semi-solid-state batteries, a polymer electrolyte may be made into gel to give it fluidity; mixed with an active material; applied to a current collector, an electrolyte polymer or a separator; and applied to one or both of a current collector, an electrolyte polymer and a separator so that an electrode is located between an electrolyte polymer and a current collector, and the electrode is interposed.

Further, in the present invention, it is possible to form both electrodes of a lithium ion secondary battery by applying a slurry composed of an electrode active material, a conductive auxiliary agent and a binder to a current collector and drying the slurry, and in all-solid-state batteries, it is possible to form a solid electrolyte film by applying a slurry composed of an electrode particle, a conductive auxiliary material, a binder and a solvent to a current collector and heating the slurry to form an electrode, and then injecting a liquid or gel-like electrolyte between electrode particles and drying the electrolyte.

A slot nozzle is effective because it can increase a production speed, but an “on roll” that is set facing with a heating and sucking roll or a heating roll has the following problems. When using a solvent of water or N-heptane that dissolves or disperses PVDF which is the above-mentioned binder or a rubber binder, alone or in combination with an organic solvent that can well dissolve a binder such as normal methylpyrrolidone (NMP), heat of a heating and sucking roll or a heating roll as a back roll at the time of applying is conducted to a tip of a slot nozzle, and a solvent in the tip of the slot nozzle is volatilized especially when the applying is stopped.

Further, in an electrode formation of a fuel cell, there is an adverse effect that an evaporated component of a solvent of a slurry such as water and alcohol condenses on a tip of a slot nozzle which does not heat due to a temperature difference, the condensed solvent adheres to an applied surface of the slurry, and it is not possible to form a uniform pattern even after an intermittent applying is completed.

To prevent this, there is a method for heating a device including a nozzle, but if the device is heated, a nozzle tip of a slot nozzle tends to dry, skinning occurs at a nozzle opening section, and a slurry discharge tends to be unstable.

It is out of the question that overall skinning occurs at an opening section of a slot nozzle, even if the skinning occurs partially with a very small amount, a streak occurs in the industry term to be a fatal defect.

If a solvent is water, there is a problem that a binder having overall skinning can not be redissolved in water.

In addition, even if an sucking roll is polished with a polishing device to a roundness of several microns or less at room temperature, the roll has a complicated structure, thereby when the roll is heated, the roll is flexed and deformed greatly and the roundness of the roll was extremely poor, so it is extremely difficult to apply a thin film by a slot nozzle on an on roll of a heating and sucking roll.

As mentioned above, when a roll having a complicated internal structure such as a heating and sucking roll is heated, the roll is greatly deformed. Even with such a roll, Japanese Patent Application Laid-Open No. 2010-149275 invented by the present inventors discloses an epoch-making method that it is possible to solve above problem and reduce a roundness of a heating and sucking roll to 5 micrometers or less at an application temperature.

However, it is necessary to polish a roll since a roundness of the roll changes every time a temperature of the roll changes. High cost occurs since not only a productivity is reduced due to an interruption of a work, but also a polishing work by a special device is needed each time.

If a heating and sucking roll is deformed, there is a problem that a distance between a tip of a nozzle and a substrate changes and a place where the distance is too far occurs when performing a method known in the industry as a slit nozzle, slot nozzle or slot die that comes into contact with a substrate via a liquid film.

If such a phenomenon occurs, especially when an applying with a relatively thin film being wet and having thinness of 20 micrometers or less, a large scaly porous applying surface is formed at a place where a distance between a tip of a nozzle and a substrate is far, thereby it is extremely difficult to obtain a uniform-applying surface.

Patent Document 2 proposes a method for cooling a roll that adsorbs an electrolyte membrane, applying an electrode ink to the electrolyte membrane by a slit nozzle, rotating and moving the roll, and heating the electrode ink on the electrolyte membrane adsorbed on a cooling roll with hot air or infrared rays, etc. in a subsequent process.

However, if this method is applied, it takes time to heat after applying, so when a low viscosity slurry is applied, there is a problem that quality deteriorates due to movement and surface flow due to a difference in precipitation speed due to a difference in a specific gravity of a slurry particle on an applying surface until drying.

### PATENT DOCUMENTS

Patent document 1: JP2019-507469A
Patent document 2: JP2015-15258A

### SUMMARY

The present invention is made to solve such a problem and improve a highest quality and productivity at a low cost. In detail, the present invention is made to satisfy following. That is, a roundness of a heating and sucking roll and a heating roll is not pressured in order to reduce a cost. A slurry applied to a substrate is rapidly dried to form a uniform applying film. Since an emphasis is not placed on a roundness of a heating and sucking roll, etc., a producing cost is reduced to the utmost limit.

On the other hand, a straightness of a tip of a slot nozzle is kept in 5 microns or less and even 2 microns or less by polishing the tip by a high-precision polishing device at room temperature. It is common knowledge in the industry that a cost is not high even if a slot nozzle is polished with high precision at room temperature, so the slot nozzle is used at room temperature so that a heat effect of a heating and sucking roll or a heating roll is negligible level or almost negligible level. In the industry, it is easy to keep a roundness of a small diameter roll within ±1.5 micrometer by polishing at room temperature.

In addition, according to an air assist slot nozzle that supports applying with compressed gas, a mist ejection slit nozzle, a multi nozzle type melt-blown spray nozzle head with a two-fluid spray that atomizes with compressed gas, it is possible to perform applying on an on roll such as a drum since it is less affected by heat from a heating and sucking drum or a heated small diameter roll, etc. due to a flow of gas.

Further, since a method of an on roll momentarily volatilizes a solvent and does not damage an electrolyte membrane, it is also suitable for forming an electrode on an electrolyte membrane and a gas diffusion layer of a fuel cell.

The present invention is made to solve the above-mentioned problems. The present invention utilizes a small diameter roll having a high roundness that is not heated and combines the small diameter roll with a large diameter heating and sucking roll or a heating roll having a diameter of 200 to 1000 mm or more, installs a slot nozzle on an on roll or an off roll of the small diameter roll that is not heated and allows continuous or pattern coating of a slurry while maintaining a high precision distance between a substrate and a tip of the slot nozzle.

Since a small diameter roll may have a simple shape, it is able to maintain a roundness of the small diameter roll accurately even when the small diameter is heated.

According to the present invention, it is possible to perform an applying by an air assist slot nozzle that uses a compressed gas for keeping a distance between a head and a substrate on a heating and sucking belt or a heating belt, a mist ejection slit nozzle or a melt blown type spray nozzle head, etc., and a drying instantly.

An object of the present invention is to form an electrode having a high quality for a fuel cell and an electrode for a secondary battery, and, is to produce next-generation secondary battery including a stackable and high-performance fuel cell, secondary battery, all-solid-state battery and air battery at high speed to provide in large quantities when forming an electrolyte layer such as an all-solid-state battery and a polymer lithium battery.

More specifically, a high-performance secondary battery or fuel, etc. is produced by applying an electrode slurry, etc. by a slot nozzle just before a substrate for a secondary battery by roll-to-roll moves to a heating and sucking roll or a heating roll, instantly volatilizing a solvent on a heating and sucking roll, a heating roll, a heating belt or a heating and sucking belt, etc. to form a high-performance electrode layer, etc., and laminating an electrolyte layer.

It is noted that a movement of a substrate may be continuous or intermittent. If a good electrode pattern is desired and a beauty of the pattern at the start or end of applying is desired, and an applying of a slurry with a particularly low viscosity is performed, it is possible to achieve the good electrode pattern and the beauty of the pattern by stopping a substrate at the start or end of applying by a slot nozzle or an air assist slot nozzle, moving a nozzle away from a substrate at the end of applying, and moving a nozzle closer to a substrate at the start of applying.

Also, when an applying is performed while traversing a melt blown type spray nozzle head, mist ejection slit nozzle, etc. orthogonal to a moving direction of a substrate, it is desirable to move a heating roll etc. intermittently and perform an applying at the timing of stop of a heating roll etc., and when applying a slurry as particles, the applying may be performed on an on roll.

Of course, in case of a single-leaf substrate, it is possible to form a desired electrode pattern by setting a substrate on a heating table or a heating suction table instead of a heating transfer device such as a heating and absorbing roll, relatively moving the substrate and an applying device selected from an air assist slot nozzle, a mist ejection slit nozzle and a melt blown type spray nozzle, and applying an electrode slurry.

The present invention provides a method for producing a battery by continuously or intermittently moving a long substrate for a battery and applying an electrode slurry to the substrate to form an electrode using a slot nozzle, comprising:

providing a heating and sucking roll capable of suction of the substrate;

providing at least one small diameter roll upstream of the heating and sucking roll, the at least one small diameter roll being close to the heating and sucking roll and having a smaller diameter than the heating and sucking roll; and

applying, by using a slot nozzle, on the substrate located on the small diameter roll or located within a region extending from the small diameter roll to the heating and sucking roll and being not in contact with neither the small diameter roll nor the heating and sucking roll,

wherein the heating and sucking roll being a heating and moving means for heating and moving a substrate to which an electrode slurry is applied.

The present invention provides the method, wherein

the heating and moving means is selected from a heating and sucking roll, a heating roll, a heating belt or a heating and sucking belt as a moving means of a substrate, and

the substrate moves under a tension of 5 to 150 newtons at a position where the substrate is detached from the moving means.

The present invention provides the method, further comprising:

applying a tension of 5 to 150 newtons to the substrate before and after the small diameter roll; and

applying the electrode slurry on an off roll before and after the small diameter roll.

The present invention provides the method, wherein

the slot nozzle is an air assist slot nozzle or a mist ejection slit nozzle,

further comprising

setting a distance between the substrate and a nozzle head to 0 to 30 mm.

The present invention provides a method for producing a battery being a second battery or a fuel battery, comprising:

selecting at least one of a heating and sucking roll, a heating roll, a heating belt, or a heating and sucking belt as a heating and moving means of a substrate; and

applying an electrode slurry to a substrate moved by the heating and moving means while an air assist slot nozzle, a mist ejection nozzle with compressed gas or a melt blown type spray nozzle head using an air curtain with compressed gas is faced to the heating and moving means and moved relative to the heating and moving means.

The present invention provides the method, wherein

the heating and sucking roll or a heating roll has a roundness of ±50 micrometers or less, and

further comprising

applying an electrode ink on an off roll immediately before the heating and sucking roll or the heating roll comes into contact with a substrate.

The present invention provides the method, wherein

the substrate is selected from a current collector, an electrolyte membrane, a separator and an electrode layer/electrolyte layer forming current collector, and

the electrode slurry is selected from an electrode slurry, an electrolyte slurry and an electrolyte solution.

The present invention provides the method, wherein

the second battery is an all-solid battery or a semi-solid battery.

The present invention provides the method, further comprising

setting a temperature of the slot nozzle or the slurry to equal to or lower than a boiling point of a solvent contained in the slurry, wherein

a temperature of the heating and sucking roll is 30° C. or more higher than the temperature of the slot nozzle or the slurry.

The present invention provides the method, further comprising

handling the slurry at a room temperature.

The present invention provides a method for producing a battery by continuously or intermittently moving a long substrate for a battery and applying an electrode slurry to the substrate in combination with a compressed gas to form an electrode,

including:

selecting at least one of a heating and sucking roll, a heating roll, a heating belt or a heating and sucking belt as a heating and moving means of a substrate; and

applying an electrode slurry to a substrate moved by the heating and moving means while an air assist slot nozzle, a mist ejection nozzle with compressed gas or a melt blown type spray nozzle head using an air curtain with compressed gas is faced to the heating and moving means and moved relative to the heating and moving means,

in which the battery is a secondary battery or a fuel cell.

The present invention provides a method for producing a battery by setting a battery substrate on a heating table or a heating and sucking table and applying an electrode slurry to the substrate by an applying machine using a compressed gas to form a square electrode,

including:

when forming the square electrode on the substrate by moving relative to the substrate, applying the electrode slurry to form the square electrode without using a mask to at least two of the four sides of the square electrode,

in which the battery is a secondary battery or a fuel cell and,

the applying machine is an air assist slot nozzle, a mist ejection nozzle with a compressed gas or a melt blown type spray nozzle head using an air curtain with a compressed gas.

With respect to the electrolyte of the present invention, it is possible to use a gel polymer, a dry polymer, etc. in a semi-solid battery, and it is possible to use a sulfide type, an oxide type, etc. in an all-solid-state battery.

According to a method for producing an electrode for a secondary battery, etc. of the present invention, it is possible to apply a slurry such as an electrode to a substrate such as a current collector by a slot nozzle, an air assist slot nozzle, a mist ejection slit nozzle or a melt blown spray nozzle head, and instantaneously move to a heating and sucking roll, etc. or perform an applying on the heating and sucking roll, etc. and instantly dry to touch at least.

It is ideal because it is possible to volatilize 99% or more of a solvent amount instantly for example within 3 seconds after wetting a substrate and thereby maintain a desired applying distribution and improve an adhesion between the substrate and an electrode and reduce an interfacial resistance.

Further, in the present invention, since it is possible to use a method for performing an applying by not only a slot nozzle method but also a mist ejection slit nozzle and a melt blown type spray nozzle head, it is possible to perform an applying of material consisting of active materials, electrolytes, conductive aids, etc. by separate and independent nozzle heads or an applying of one type of slurry in which they are mixed or a slurry manufactured by mixing at least two types of materials with mechanochemicals in the form of mist (including making a state of spray particles and making into fumes by ultrasonic waves or bubbling).

Since it is possible to apply a method of ejecting in the form of mist to a spray method or a pulse-like spray method belonging to a spray, it is possible to arrange each head of a slurry made of active material particles, a slurry made of an electrolyte, and a slurry made of a conductive additive, etc. in a desired order or in any order in a flow direction of a substrate, and form a desired mixed state by performing an applying of each desired amount with a thin film or in a dispersion and a laminating.

Since a method of performing an applying as particles can form fine irregularities and increase a surface area of electrodes, etc., the method can lead to an improvement of a battery performance.

Further, it is more effective since a combination of a slightly large unevenness and a fine unevenness of a pulsed pattern is formed by performing an applying in a pulsed manner.

Further, it is possible to perfume a laminating by a combination of a slot nozzle and a mist ejection slit nozzle, and combine with them or one of them and a melt-blown spray nozzle to perform spray or pulse-like spray.

It is noted that a melt blown type spray nozzle refers to a nozzle in which a plurality of ejection ports (nozzles) are arranged in one row or a plurality of rows in one head, to spray a liquid such as a slurry or a molten resin on a wide substrate by a compressed gas such as pressurized air, etc.

Further, the present invention is not limited to a single nozzle head as described above, it is possible to arrange a plurality of heads in a plurality of rows in a moving direction of a substrate or a traverse direction of the head and perform laminating with a thin film Especially since it is possible to adjust an amount of electrodes of one layer per square centimeter to 0.01 to 0.3 mg which is a very small amount of stacking weight by using an air assist slot nozzle, a mist ejection slit nozzle or a melt blown type nozzle head, it is effective for a conductive aid and high-performance material to be added in a small amount.

Therefore, in the present invention, it is possible to perform a laminating for example 2 to 30 layers of thin films. It is possible to reduce an applying amount per layer by combining with a heating and sucking drum, etc., it is possible to reduce a solid content of a slurry or a solution to 10% or less by weight for example 3% or less in order to reduce further the applying amount per layer.

It is extremely difficult to apply such a low solid content, low viscosity material in a pattern such as a rectangle by a slot nozzle method, but it is possible to achieve an object by using an air assist slot nozzle, a mist ejection slit nozzle or a melt blown type spray head of the present invention.

Further, in the present invention, it is possible to form a sharp applying line by providing an air curtain means with a compressed gas at a spray pattern end (the end of the end pattern of a plurality of spray patterns) on at least one side of a mist ejection slit nozzle or a melt blown type nozzle head.

It is also possible to provide an air curtain means at the ends of the spray patterns on both sides. It is possible to form an electrode pattern with extremely little scattering of particles by setting a spray angle of each nozzle of a meltblown spray head to 20 degrees or less preferably 15 degrees or less, and a distance between a substrate and the nozzle to 70 mm or less preferably 40 mm or less.

It is possible to form a better unmasked electrode pattern in combination with the above-mentioned the air curtain means with a compressed gas. This method is also effective for forming an electrode pattern on an electrolyte membrane of a fuel cell.

It is also included a method that does not require a mask by performing an applying to generate a spray pattern in layers so that the spray patterns wrap with one or more nozzles by using a micro curtain coat method that uses an airless spray nozzle to spray at a low pressure of for example 0.2 to 0.5 MPa and perform an applying using a part of a liquid film before it becomes particles. This method is particularly effective for forming an electrode in a fuel cell.

Although it is possible to perform an applying on roll in a micro curtain coat method, it is important to level an electrode slurry on a substrate as much as possible and then dry it in order to improve an applying film distribution, and it is preferable to perform an applying on an off roll immediately before a heating roll, etc.

A flow rate distribution at the moment of applying of a micro curtain becomes a fishtail pattern with a large application flow rate at both ends of a spray, and a solvent volatilizes instantly on a heating roll, thereby it is set with the same pattern.

Therefore, it is possible to improve an electrode performance since it is possible to increase a surface area by performing an applying to generate multiple patterns with pitch feed, etc. if fine view is not pursued. In particular, if it is applied to an electrode formation of a fuel cell, it is effective since it is possible to completely eliminate a mask in a traverse direction.

A merit of making a solid content concentration as described above is that the more thinner the film is laminated, the more uniform the applying amount per unit area becomes even if the desired trace amount of material is used, thereby it is possible to create an ideal mixed state of multiple materials by laminating not only a single material but also alternately.

Further, in the present invention, for example, if a coating the same or different materials on the opposite surface of a substrate applied with a slurry, etc. is performed, it is possible to temporarily dry quickly since it has good heat conduction to a substrate when performing an applying while moving the substrate by stacking a microporous breathable substrate, a heat-resistant breathable plastic film such as dust-free paper and PVDF on the substrate, heating for example a heating and sucking drum at 50 to 200° C. through them, and performing for example suction with a commercially available inexpensive vacuum pump with a vacuum degree of about −60 kPa.

Since a breathable substrate is intended not to damage an applied surface, it is economical to wind the breathable substrate around a heating and sucking drum and use it.

Further, it is possible to laminate a mask on a current collector, etc. as a substrate in addition to the above air curtain means in order to form a desired electrode pattern,

It is possible to form an accurate electrode pattern by sprinkling an adhesive in a porous shape especially on both sides other than an electrode forming section of a substrate using a gravure roll, etc., attaching a masking substrate hollowed out to an electrode size to the substrate, moving the substrate and using not only a slot nozzle and a spray method.

The masking substrate is particularly effective for a mist ejection slit nozzle or a melt blown spray method, which atomizes a slurry.

It is possible to use for example a porous ceramic cylindrical molded body of alumina having good heat conduction as a heating and sucking roll, and it is possible to produce the heating and sucking roll by forming many holes having a diameter of 0.1 to 1 mm in a cylinder such as stainless steel, etc. at a pitch of 1 to 3 mm for example in a staggered pattern. It is possible to form innumerable holes usually by a laser or an electron beam, etc.

In order to make the suction distribution more uniform even with large or coarse pores, it is possible to use by laminating a dust-free paper, a porous film, etc. such as micrometer order on a substrate on a surface of a drum and carrying, or winding around a heating and sucking drum to fix.

In case of winding, it is economical since it is possible to produce a heating and sucking drum at low cost by preparing for example multiple layers can be wound or multiple breathable substrates and laminating finer ones in order from coarser ones.

In addition, since a breathable substrate on the order of micrometer or nanometer has the same effect as a heating and sucking drum on the order of micrometer or nanometer, the cost performance is outstandingly good in terms of performance. Alternatively, they can be used in unwinding or winding together with a substrate, not limited to a single or plural.

According to the present invention, even if it becomes a substrate that is easily deformed and difficult to handle due to an unexpected ultra-thin film in the future, for example, an electrolyte membrane of 10 micrometers or less of a fuel cell, it is possible to form quality-stable electrodes or electrolyte layers, etc. to produce a battery such as a fuel cell and a secondary battery by directly applying an electrode slurry, etc. as a thin film by a slot nozzle, etc., and stacking electrode slurrys if necessary.

As described above, according to the present invention, it is possible to form high-quality electrodes and electrolyte layers, and furthermore, produce secondary batteries, etc. such as high-performance all-solid-state batteries, etc. and fuel cells.

### BRIEF DESCRIPTION OF DRAWINGS

FIG. 1 shows a schematic cross-sectional diagram of an arrangement of a heating (sucking) roll, a small diameter roll, a substrate and a slot nozzle according to the present embodiment.

FIG. 2 shows a schematic cross-sectional diagram of a combination of a heating (sucking) roll, a small diameter roll, a substrate and a slot nozzle according to the present embodiment.

FIG. 3 shows a schematic cross-sectional diagram of an arrangement of a heating (sucking) roll, a substrate, a small diameter roll, a slot nozzle, etc. and a moving direction of a breathable substrates, etc. according to the present embodiment.

FIG. 4 shows a schematic cross-sectional diagram of an inverted substrate for forming a second electrode and other constructs according to the present embodiment.

FIG. 5 shows a schematic cross-sectional diagram of a moving direction of a substrate, etc. in the advanced version of forming a second electrode according to the present embodiment.

FIG. 5-2 shows a schematic diagram of applying while traversing a melt-blown spray head perpendicular to a traveling direction of a substrate on a heating (sucking) roll according to the present embodiment.

FIG. 6 shows a schematic cross-sectional diagram of electrodes formed on both sides of a substrate according to the present embodiment.

FIG. 7 shows a schematic cross-sectional diagram of an air assist slot nozzle according to the present embodiment.

FIG. 8 shows a schematic cross-sectional diagram of a pattern coat on a substrate by a mist ejection slit nozzle according to the present embodiment.

FIG. 9 shows a schematic diagram of a pattern coat by a melt-blown spray nozzle head with an air curtain means using compressed gas according to the present embodiment.

FIG. 9-2 shows a schematic diagram of a pattern coat by a melt-blown spray nozzle head with an air curtain means using compressed gas, according to the present embodiment.

FIG. 10 shows a cross-sectional diagram of a spray from a melt-blown spray nozzle head with an air curtain means according to the present embodiment.

### DETAILED DESCRIPTION

Now, a preferred embodiment of the present invention will be described with reference to the drawings. However, the embodiment below is only an example for facilitating the understanding of the present invention. Addition, replacement, deformation, or the like executable by those skilled in the art can be made thereto without departing from the technical idea of the present invention.

The drawings schematically show the preferred embodiment of the present invention.

In FIG. 1, a small diameter roll 4 having a diameter smaller than a heating and sucking drum 1 is provided upstream of the heating and sucking drum 1, a substrate 2 unwound by an unwinding device 5 is fed so as to pass through a nip roll 10, applied with an electrode slurry etc. (not shown) by a slot nozzle 3 on a off roll between the small diameter roll 4 and the heating and sucking drum 1, and then wound by a downstream winding device 6. The heating and sucking drum 1 can wind one or more micrometer-order breathable substrates (not shown) thereon. An electrode may be formed on the opposite side of the substrate 2. Further, an applying to the substrate 2 by the slot nozzle 3 may be performed by an on roll on the small diameter roll 4 or by an off roll before and after the small diameter roll 4 up to the heating and sucking roll 1. It is ideal in terms of dryness because a heating and an sucking start almost at the same time as the applying when the applying is performed on the off roll just before the heating and sucking drum 1. Especially when the applying is performed on the off roll, it is desirable that a tension of 5 to 150 newtons is applied to the substrate 2. Because an open/close valve mechanism in the slot nozzle 3 can perform a clean cut by using a sackback type (not shown) commonly used in the industry, it is possible to form a rectangular or square electrode pattern. Further, by assembling a shim having a desired pattern dimension, it is possible to provide a plurality of patterns orthogonal to a moving direction.

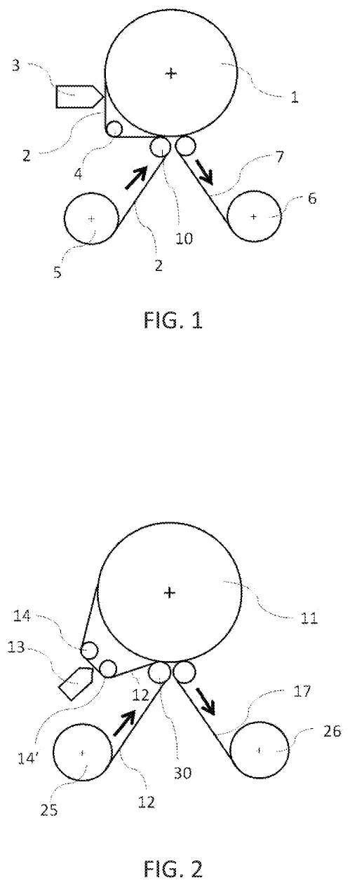

FIG. 2 shows a diagram in which a plurality of small diameter rolls 14, 14′ are installed in a configuration of FIG. 1. A slot nozzle 13 may be arranged on the on roll on the small diameter rolls 14, 14′ or on the off roll before and after the small diameter rolls 14, 14′. Further, the small diameter rolls 14, 14′ may be heated.

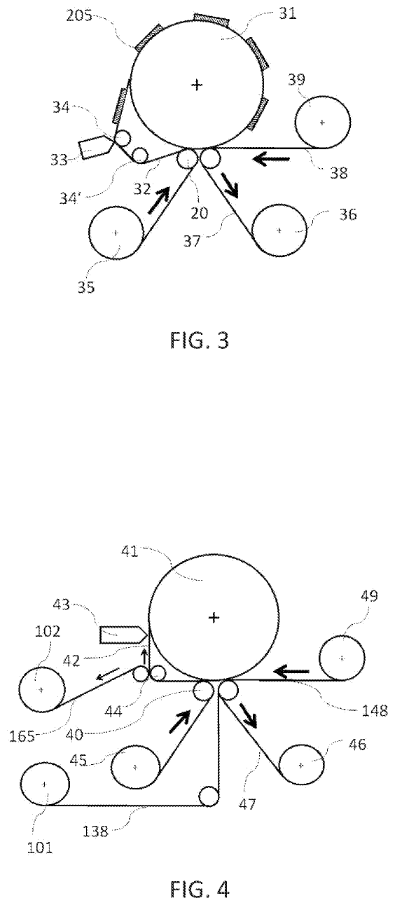

In FIG. 3, the electrode slurry is applied to a substrate 32 by a slot nozzle 33 with the on roll on a small diameter roll 34 to form an electrode pattern 205. A protective substrate 38 unwound and fed from a protective substrate unwinding device 39 is laminated on the substrate 32 and the electrode 205 dried on the heating and sucking roll 31 to be wound up as a composite by a winding device 36. The protective substrate may be a breathable substrate without limiting material, type and shape, and may be selected from those that are the cheapest in terms of cost and that do not transfer or are difficult to transfer an electrode thereto. It is possible to perform an applying using a slot nozzle on a heated small diameter roll having good roundness. An air assist slot nozzle, a mist ejection slit nozzle, and a meltblown type spray are effective on the heated small diameter roll, and by using them, it is possible to perform an applying on the heating and sucking roll.

In FIG. 4, a backsheet 165 is peeled off and wound by a backsheet winding device 102 upstream of a position where a first electrode is formed on the substrate 42. A position where the first electrode is formed on one side of the substrate 42 is detected by a detection sensor, and the electrode slurry is applied by the slot nozzle 43 to form the second electrode or the same electrode on the outer side of the substrate 42. A breathable substrate 138 moves on the heating and sucking drum while protecting the first electrode is wound by the breathable substrate winding device 101. A substrate having the first and second electrodes thereon is wound together with new protecting substrate 148 by a winding device 46. The protecting substrate may be a breathable substrate, one that does not affect the electrode surface and has a low cost can be selected as the protecting substrate.

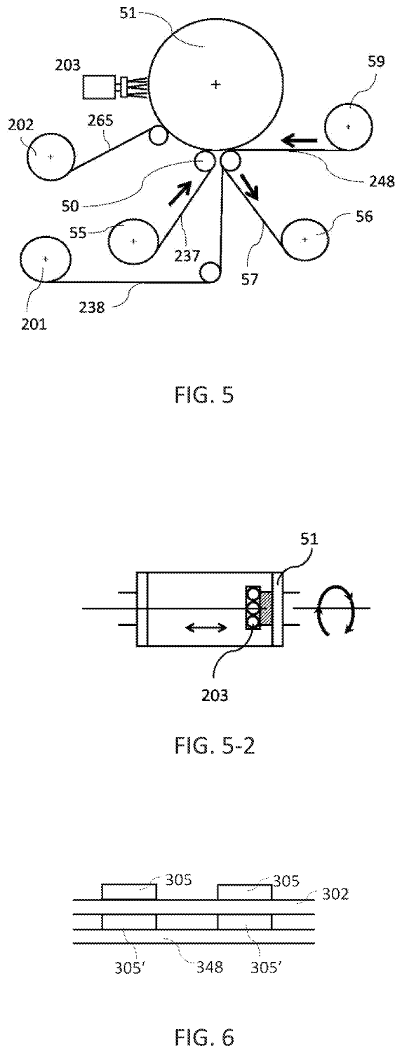

FIG. 5 shows a schematic cross-sectional diagram in which a forming an electrode is performed by a spray method instead of the slot nozzle. Except for the spray method, a configuration in FIG. 5 can be almost the same as the configuration in FIG. 4. An air assist slot nozzle applying method that applies an electrode ink with compressed gas along an electrode ink flowing out from a slot nozzle or a mist ejection slit nozzle for using an electrode slurry as mist or is preferable. Alternatively, according to an applying method using a melt blown type spray nozzle head 203 that consists of a narrow angle spray group combined an air curtain means by compressed gas, it is possible to eliminate a mask. However, in other general spray method, due to large scattering of spray particles, a mask with a desired pattern shape should be installed. The substrate may be an electrolyte membrane for a fuel cell or a separator for a lithium ion battery. Further, this method is not limited to a formation of a second electrode and can form an electrode or an electrolyte layer on only one side of the substrate.

FIG. 5-2 is a diagram that shows a pattern being applied to the substrate on the heating drum (roll) 51 of FIG. 5 by the melt blown type spray nozzle head 203 that traverses perpendicular to travelling direction of the substrate. By increasing a number of spray nozzle of the spray head 203, it is possible to widen a total applying pattern width.

In a cross-sectional diagram of FIG. 6, a first electrode 305 and a second electrode 305′ are formed on both sides of a substrate 302 and a protecting substrate 348 is laminated on the second electrode 305′. It is suitable for a fuel cell in which the substrate is an electrolyte membrane and a positive electrode and a negative electrode are formed. When stacking a current collector and an electrode in multiple layers in a second battery, the second electrode may be an electrode having the same pole as the first electrode.

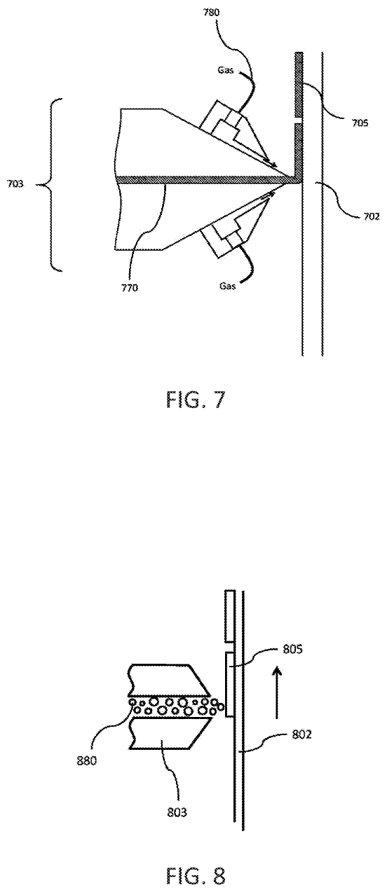

FIG. 7 shows a schematic cross-sectional diagram of an air assist slot nozzle (MS). An electrode slurry 770 passes through an inside of the MS as a liquid film and is discharged from a tip of a head of the MS. At the same time, the liquid film is assisted by compressed gas flowing out from both sides of the head and is applied to a substrate 702 to become an electrode. In particular, when applying intermittently to form a square pattern, it is possible to form a sharp edge of an electrode pattern 705 by adjusting an on/off timing of compressed gas with respect to an on/off of the electrode slurry. An outflow of compressed gas may be continuous or intermittent. When a surface of the substrate is uneven, it is particularly effective because the slurry can be pushed in the surface by a force of compressed gas. By mixing a solvent fine particle in the compressed gas, it is possible to moisten a tip of a nozzle and prevent a buildup of solid matter.

FIG. 8 shows a schematic cross-sectional diagram of a mist ejection slit nozzle 803. It is possible to form an electrode 805 by applying an electrode mist 880, which is mist, to a substrate 802 while moving a mist ejection slit nozzle 803 and the substrate 802 relative to each other. A mist can be atomized by ultrasonic waves, bubblers or colliding spray particles with a liquid surface, etc. at a close distance upstream of the slit nozzle, and can be moved to an inside of the slit nozzle by a carrier gas. Alternatively, it is possible to spray an electrode slurry with compressed gas to make spray particles in a slit nozzle having a wide slit groove width, and eject the electrode slurry from an opening of the slit nozzle. In the slit nozzle, the slit groove width 890 extends to a desired length in a substrate width direction orthogonal to a moving direction of the substrate 802 to form a slit opening section. It is noted that the slit groove width 890 may be 1 to 30 mm in a moving direction relative to the substrate, and a slit length can be longer than the slit groove, for example 50 to 1500 mm. For example, when an applying to a substrate having an applying width of 1000 mm is performed, a slit nozzle having a slit length of 1000 mm may be used, and the slit nozzle may be arranged orthogonal or substantially orthogonal to a traveling direction of the substrate. When using a nozzle having a narrow width, for example 100 mm slit length, it is possible to perform applying to make a 1000 mm×100 mm pattern by traversing a 100 mm narrow slit nozzle orthogonally to a traveling direction of the substrate. In the case of intermittent pattern applying, by setting a slit groove width to 5 mm or less with respect to a moving direction of the substrate, it is possible to maintain the sharpness and film thickness distribution with respect to an edge of a pattern at the start and end of applying. Further, when the slit groove width is 10 mm or more, it is suitable for a continuous applying method because the same effect as thin film lamination is obtained. Of course, it goes without saying that it is better to arrange a plurality of mist ejection slit nozzles in a plurality of rows in the moving direction of the substrate.

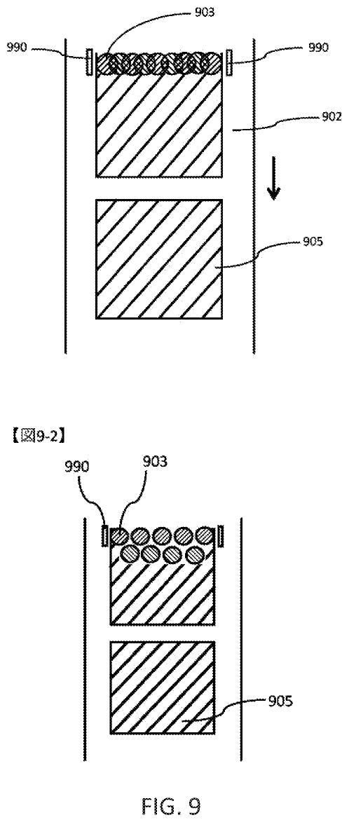

In FIG. 9, a plurality of narrow angle spray nozzles of a melt blown spray nozzle head are arranged in a row so that adjacent spray patterns 903 interfere with each other, and it is possible to overpaint finally in the end while shifting a spray timing in a pulsed manner by two independent opening/closing mechanisms upstream of adjacent spray nozzles to prevent a spray flow from interfering in an air. Further, it is possible to form an electrode 905 while flowing a fine compressed gas to closest positions to the both ends of a spray pattern by each air curtain nozzle 990 so that spray particles do not flow outside. In FIG. 9-2, a plurality of nozzles of the melt blown type spray nozzle head are arranged in two rows, and it is possible to obtain the same effect.

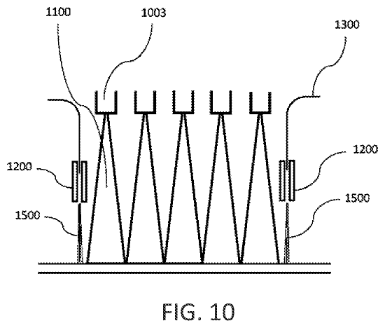

FIG. 10 shows spray flows 1100 from multiple spray nozzles 1003 arranged in a row on a melt blown type spray nozzle head and formation of air curtains by flowing compressed gas from each air curtain nozzle 1200 for not scattering particles outside both of the outermost ends of a spray flows sprayed on a substrate 1002 outside. When a substrate is a fuel cell electrolyte membrane, it is possible to form an electrode having a width between air curtains at both ends without a mask by traversing a melt blown spray nozzle head perpendicular to a traveling direction of the electrolyte membrane. It is possible to obtain a uniform distribution by performing spraying in a pulsed manner and moving at pitch so that spray patterns overlap. It is possible to increase uniformity by arranging multiple spray nozzles in 2 to 5 rows and increase productivity by increasing traverse speed.

The present invention is particularly effective for next generation secondary battery such as all-solid batteries and semi-solid batteries among secondary battery and is able to be applied more widely. It is effective for forming an electrode of supercapacitor. It is effective for forming an electrode of a fuel cell. Further, it is effective for products to which a coating agent or a glue/adhesive containing a functional material for applying a liquid or a melt to a long substrate in a roll-to-roll method is applied. It is effective for a wide range application in different fields other than wallpaper and labels, etc. as building materials, etc., for example resist coating in an electronics field, coating in a flat panel display field and coating on pharmaceutical patches, etc. as new delivery system, etc.

### DESCRIPTION OF THE REFERENCE NUMERAL

1, 11, 31, 41, 51 Heating (Heating and sucking) drum
2, 12, 32, 42, 302, 702, 802, 902 Substrate
3, 13, 33, 43 Slot nozzle
4, 14, 14′, 34, 34′, 44 Small diameter roll
5, 25, 35, 45, 55 Substrate unwinding device
6, 26, 36, 46, 56 Substrate winding device
7, 17 Current collector/electrode
10, 20, 30, 40, 50 Nip roll
38, 138, 148, 248, 348 Electrode protecting substrate (Breathable substrate)
39, 49, 59 Electrode protecting substrate unwinding device
101, 201 Electrode protecting substrate winding device
102, 202 Backseat winding device
203 Spray applying head (Melt blown type spray nozzle head)
205, 705, 805, 905 Electrode
305 First electrode
305′ Second electrode
703 Air assist slot nozzle
770 Electrode slurry
780, 1300 Compressed gas line
803 Mist ejection slit nozzle
880 Electrode mist
903 Spray applying pattern
990, 1200 Air curtain nozzle
1003 Spray nozzle
1100 Spray flow
1500 Air curtain

1-10. (canceled)

11. A method for producing a battery by continuously or intermittently moving a long substrate for a battery and applying an electrode slurry to the substrate to form an electrode using a slot nozzle, comprising:
providing a heating and sucking roll capable of adsorption of the substrate;
providing at least one small diameter roll upstream of the heating and sucking roll, the at least one small diameter roll being close to the heating and sucking roll and having a smaller diameter than the heating and sucking roll; and
applying the electrode slurry, by using a slot nozzle, on the substrate located from a position on the small diameter roll to a position where the substrate comes into contact with the heating and sucking roll;
wherein the heating and sucking roll being a heating and moving means for heating and moving a substrate to which an electrode slurry is applied.

12. The method according to claim 11, wherein
the heating and moving means is selected from a heating and sucking roll, a heating roll, a heating belt or a heating and sucking belt as a moving means of a substrate, and
the substrate moves under a tension of 5 to 150 newtons at a position where the substrate is detached from the moving means.

13. The method according to claim 11, further comprising:
applying a tension of 5 to 150 newtons to the substrate before and after the small diameter roll; and
applying the electrode slurry on an off roll before and after the small diameter roll.

14. The method according to claim 11, wherein
the slot nozzle is an air assist slot nozzle or a mist ejection slit nozzle,
further comprising
setting a distance between the substrate and a nozzle head to 0 to 30 mm.

15. A method for producing a battery being a second battery or a fuel battery, comprising:
selecting at least one of a heating and sucking roll, a heating roll, a heating belt or a heating and sucking belt as a heating and moving means of a substrate; and
applying an electrode slurry to a substrate moved by the heating and moving means while an air assist slot nozzle, a mist ejection nozzle with compressed gas or a melt blown type spray nozzle head using an air curtain with compressed gas is faced to the heating and moving means and moved relative to the heating and moving means.

16. The method according to claim 12, wherein
the heating and sucking roll or the heating roll has a roundness of ±50 micrometers or less, and
further comprising
applying an electrode ink on an off roll immediately before the heating and sucking roll or the heating roll comes into contact with a substrate.

17. The method according to claim 11, wherein
the substrate is selected from a current collector, an electrolyte membrane, a separator and an electrode layer/electrolyte layer forming current collector, and
the electrode slurry is selected from an electrode slurry, an electrolyte slurry and an electrolyte solution.

18. The method according to claim 15, wherein
the second battery is an all-solid battery or a semi-solid battery.

19. The method according to claim 11, wherein
a temperature of the slot nozzle or the slurry is equal to or lower than a boiling point of a solvent contained in the slurry, wherein
a temperature of the heating and sucking roll is 30° C. or more higher than the temperature of the slot nozzle or the slurry.

20. The method according to claim 19, further comprising
handling the slurry at a room temperature.

21. The method according to claim 15, wherein
the substrate is selected from a current collector, an electrolyte membrane, a separator and an electrode layer/electrolyte layer forming current collector, and
the electrode slurry is selected from an electrode slurry, an electrolyte slurry and an electrolyte solution.

22. The method according to claim 15, wherein
a temperature of the slot nozzle or the slurry is equal to or lower than a boiling point of a solvent contained in the slurry, wherein
a temperature of the heating and sucking roll is 30° C. or more higher than the temperature of the slot nozzle or the slurry.

23. The method according to claim 22, further comprising
handling the slurry at a room temperature.
